(19) United States
(12) Patent Application Publication
(10) Pub. No.: US 2006/0012366 A1
(43) Pub. Date: Jan. 19, 2006

(54) Scanner for nuclear quadrupole resonance measurements and method therefor

(76) Inventors: John Harold Feldman, Kardinya (AU); Warrick Paul Chisholm, Ferndale (AU); Peter Alaric Hayes, Wembly Downs (AU); Vassili Timofeevitch Mikhaltsevitch, St. James (AU); Taras Nikolaevitch Rudakov, Willetton (AU); Christopher Norman Aitken, Darlington (AU)

Correspondence Address: PILLSBURY WINTHROP SHAW PITTMAN LLP, 1650 TYSONS BOULEVARD, MCLEAN, VA, 22102, US

(21) Appl. No.: 10/519,150

(22) PCT Filed: Jun. 26, 2003
(86) PCT No.: PCT/AU03/00802

§ 371 Date: Aug. 16, 2005

(30) Foreign Application Priority Data
Jun. 26, 2002 (AU) PS 3228

(51) Int. Cl. G01V 3/00

(52) U.S. Cl. 324/310; 324/318

(57) ABSTRACT

An NQR scanner for detecting the presence of a substance containing quadrupole nuclei within an object. A pulse generating means (1) generates pulse sequences that are used to irradiate the object in a pulsed magnetic field at a requisite NQR frequency for the substance to be detected. A high power RF transmit amplifier (2) amplifies the signal to produce sufficient magnetic field strength to irradiate a scan volume within which the object is disposed for detection purposes and cause an NQR transition to a detectable level within the substance if present within the object. A method for detecting the presence of a substance containing quadrupole nuclei within an object is also described

### FIELD OF THE INVENTION

This invention relates to a scanner for detecting prescribed substances using nuclear quadrupole resonance (NQR) and a method therefore. The invention has particular, although not exclusive, utility in the detection of explosives and narcotics located within mail, airport luggage and other packages using NQR. More specifically it relates to a practical system for use in NQR scanning.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background art is intended to facilitate an understanding of the present invention only. It should be appreciated that the discussion is not an acknowledgement or admission that any of the material referred to is or was part of the common general knowledge as at the priority date of the application.

NQR has been proposed as a possible detection technology to use in scanners for the detection of explosives, narcotics and other illicit substances at the entry points to secure areas such as in airports, courthouses etc. NQR can also be used for scanning hold stowed baggage in airports. The reason for this is that a common nuclei occurring within explosives, narcotics etc is the ¹⁴N nucleus. This nuclei resonates in response to a prescribed radio frequency (RF) excitation, the phenomenon known as nuclear quadrupole resonance, the nuclei emitting an NQR signal that can be detected using appropriate sensing and processing equipment. ¹⁴N NQR generally occurs at radio frequencies between 0.5-6 MHz and so irradiating an object that may possibly contain an illicit substance with the ¹⁴N nuclei with RF energy at a prescribed NQR frequency for that substance and detecting an NQR signal emitted in response thereto, may indicate passively and remotely the presence of the illicit substance within the object.

In the prior art there potentially exist many different combinations for achieving an NQR scanner, however, careful selection of the required components is required to achieve a practical large volume scanner to make it function successfully for commercial application. Large volume in this context means a volume in the order of 0.1 m³ within which packages and luggage may be disposed, as compared with volumes in the order of test tube size, which were used in the past for much of the rudimentary experimental and scientific work undertaken in relation to the NQR phenomenon.

Pursuant to the present invention, it has been discovered that there are several key features to an NQR scanner which are required to make a successful apparatus for commercial application. These include:

Coil and Shield:

For NQR scanning, the coil used should be able to produce a reasonably uniform magnetic field over the entire scan volume. This is a difficult requirement to achieve because of the large volume required to be scanned. If the field is weak at any point within its volume the substance of interest will not be excited in that part of the coil and consequently the substance will not be detected.

A further requirement is that the coil must have a high Q to detect the typical small signals from NQR samples inside large volumes.

Another requirement is that the size of the electric field should be limited and be contained so that it interferes to the smallest possible extent with the scan item of interest, if at all.

Spiral coils cannot be used for large volume applications because they firstly do not produce a reasonably uniform field over a particular volume. Secondly, the inductance values of spiral coils are very large, which means that they are difficult to resonate at high NQR frequencies. Thirdly, as they cannot contain the magnetic field they produce like solenoids, some field is wasted irradiating into a non-usable volume.

The use of spiral coils can be improved by using two coils and passing the scan item between these coils, however once again the inductance is very large and it is difficult to tune the coil. Spiral coils also suffer from a low Q, which would limit the detection sensitivity.

Solenoidal coils cannot be used as the inductance from these coils is also very large, which also means that these coils are difficult to tune at the higher end of the NQR frequencies. Solenoidal coils also become limited in Q as the number of turns becomes higher. It is possible to scan an item with an array of coils where the scan item passes between the two arrays of coils, however, such a system suffers from two problems: (i) a non uniform field, and (ii) individual coils couple together decreasing their Q and thus sensitivity.

For a practical NQR system, the shield design needs to be such that it fully encloses the coil leaving at least one opening for a scan item to pass into the volume being scanned. The shield design also needs to stop external interference from entering the scan volume and stop EM emissions from escaping from the coil volume. This requirement is due to occupational health and safety requirements for electromagnetic radiation.

Conveyor Belt:

An NQR system requires some means of transporting the scan item into the scan volume, such as a conveyor belt, which can also automatically transport the scan item to a position close to the centre of the coil. The conveyor belt needs to be able to automatically stop the scan item such that it can be scanned. The time to move the bag in and out ideally is needed to be less than 2 seconds. X-ray airport luggage scanners typically have belt speeds which are too slow and also do not stop within the scan volume unless interrupted by the operator.

Tuning:

Once the bag is within the scan volume, a tuning sequence is required. This tuning sequence is required to determine if the introduction of the scan item into the scan volume has altered the resonant frequency of the device. To achieve the re-tuning of the device, switches need to be activated to switch capacitors in or out of the circuit. Variable capacitors cannot be used for this purpose because they are large and slow in operation.

Q Switch:

A Q switch, as the name implies, changes the Q at some point during the operation of the NQR scanner. As the signals are measured typically in a high Q state, ringing, which is ever present on a coil after a transmit pulse, needs to be removed. This can be achieved by switching the Q to a lower value just after the transmit pulse has finished and thus reduce the ring down time to a small value and allow measurement of the NQR signal.

Various methods have been used for Q switching including simple resistive Q damping, phase reversal damping, capacitive or inductive damping and transformer induced damping. All of these methods have some merit in removing the ringing of the coil.

Excitation:

To detect an NQR substance, an RF energy source is required to generate a signal at the NQR frequency of interest. A programmable device is required to take the signal from the RF source and convert it into a pulse sequence, which can then be sent to the coil to irradiate the scan item in a pulsed magnetic field. This programmable device includes the ability to produce pulses of any duration and any phase.

Measurement:

The measurement process begins by detecting and amplifying the signal and then sending the received signal from the coil to a mixer. The mixer turns the signal into a quadrature signal allowing √2 improvement in the signal-to-noise ratio (SNR). The two quadrature signals are sent to an analogue-to-digital converter (ADC). Here the signal is averaged after each pulse until the pulse sequence has finished. After the averaging process is completed, the result is sent to a computer to be further processed by filters, the fast Fourier transform—and cross correlation methods to separate out the phase and amplitude of the signal. The process ends with the measured amplitude and/or phase being compared to a known range or against a threshold.

Detection:

If the one or more of the measured signal's parameters do lie within a measured range or above a threshold, then the operator is alerted by an audible alarm or visible display.

While many methods are known in theory on how to achieve an NOR scanner using the above information, it is as a result of much empirical trialling and testing by the inventors as well as the application of theoretical principles that a careful selection of components required to make a robust practical scanner that is commercially viable has been developed.

### DISCLOSURE OF THE INVENTION

It is an object of the present invention to provide a practical NOR scanner for detecting the presence of illicit substances and a method for scanning and detecting such.

In accordance with a first aspect of the present invention there is an NOR scanner for detecting the presence of a substance containing quadrupole nuclei within an object comprising:
a pulse generating means to generate pulse sequences that are used to irradiate the object in a pulsed magnetic field at a requisite NQR frequency for a substance to be detected;
a high power RF transmit amplifier for amplifying said pulse sequences to produce sufficient magnetic field strength to irradiate a scan volume within which the object is disposed for detection purposes and cause an NQR transition to a detectable level within the substance if present within the object;
a high Q, tuneable coil for producing a reasonably uniform magnetic field over the entire scan volume, connected into a tuneable circuit for varying the resonant frequency thereof;
a power matching unit to ensure optimum power transfer from said transmit amplifier to said coil at substantially every frequency the NQR scanner operates;
an electromagnetic shield to fully enclose the coil allowing an opening to pass the object into the scan volume for detection, said electromagnetic shield being adapted to stop external interference from entering the scan volume and electromagnetic emissions from escaping from the coil and scan volume;
a tuning subsystem to determine if the introduction of the object into the scan volume has altered the resonant frequency of the scanning for the substance, and to re-tune the scanner to the requisite resonant frequency;
a low equivalent series resistance (ESR) switch to switch a large capacitance into and out of the tuneable circuit for changing between low and high resonant frequencies, whilst maintaining a low equivalent series resistance to maintain a high Q in the circuit at low resonant frequencies;
a receiver system for amplifying a received signal from the coil after a delay from each transmitted pulse of the pulse sequence causing irradiation of the object and treating said received signal to improve the SNR;
processing means to process the treated signal to separate out the phase and amplitude thereof, and effect appropriate control of the pulse generating means;
an isolator to isolate the coil from the receiver system;
comparator means for comparing the measured phase and amplitude of the received signal with a known range or prescribed threshold; and
detection means to detect whether the measured signal corresponds to an NQR signal emitted by the nuclei of the substance being tested, and if present issue an alarm to notify an operator of the scanner that the substance has been detected.

Preferably, the receiving system comprises:
(i) amplification means to amplify the received signals;
(ii) a mixer to mix and enhance the received signals for improving the SNR;
(iii) an analogue-to-digital converter to digitise the enhanced signals and average the signal after each transmitted pulse until the pulse sequence has finished for subsequent digital processing; and
(iv) an accumulator or digital signal processor to accumulate the digitised and averaged signals over the pulse sequence.

Preferably, said processing means comprises a computer to process the accumulated signals by filtering, performing the fast Fourier transform, and cross-correlation techniques to separate out the phase and amplitude of the accumulated signals.

Preferably, the amplification means is a small signal amplifier.

Alternatively, the amplification means preferably comprises a cold damped amplifier consisting of a matching system and amplifier for amplifying low frequency received signals, and a high impedance amplifier for amplifying high frequency received signals.

Preferably, the coil is a multiple loop coil.

Alternatively, the coil may be a sheet single turn coil.

Preferably, the scanner includes an electric field shield circumscribing the inside of the coil within the scan volume to limit and contain the electric field produced by the coil so that it interferes to the smallest possible extent with the object being scanned.

Preferably, said scanner includes a temperature probe to measure the temperature, and said processing means calculating the requisite adjustment to the resonant frequency of the pulse sequence in the light of the temperature having regard to the substance being detected and controlling the pulse generating means to generate the pulse sequence at the adjusted resonant frequency.

Preferably, said scanner includes a Q switch to reduce the Q factor of the coil circuit to a minimum directly after a pulse of the pulse sequence is transmitted, and then return the Q of the circuit to a high level for sensing and measuring the received signal.

Preferably, said scanner includes a conveyor belt controllable to automatically transport an object to be scanned to a position close to the centre of the coil, and to automatically stop the object at such position so that it can be scanned.

Preferably, said scanner includes a second outer shield to provide extra protection against external interference from entering the scan volume.

Preferably, said pulse generating means is controlled to generate pulse sequences that combat magnetoacoustic ringing and temperature induced intensity anomaly effects.

Preferably, said scanner includes RF curtains to prevent the escape of RF interference and prevent RF noise from entering the scan volume.

Preferably, said RF curtains comprise rubber backed copper curtains.

Alternatively, said scanner includes doors to prevent the escape of RF interference and prevent RF noise entering the scan volume.

Preferably, said scanner includes a tuning probe disposed part way between the coil and the shield for the purposes of tuning the coil to the requisite frequency for detection purposes prior to scanning an object brought into the scan volume of the coil.

Preferably, said scanner includes an optical fence system to sense the presence of an object approaching the scanner for scanning, to control the conveyance of the object to the scan volume for scanning and to control subsequent discharge of the object therefrom after scanning.

Preferably, said scanner includes a remote operating pod for informing an operator of the scanner the status of the system without the need for looking at a monitor.

In accordance with another aspect of the present invention, there is provided a method for detecting the presence of a substance containing quadrupole nuclei within an object, comprising:
conveying an object to a scan volume;
determining whether the introduction of the object into the scan volume has altered the resonant frequency for detecting a prescribed substance having quadrupole nuclei within the object;
re-tuning a high Q, tuneable coil to the requisite resonant frequency with the object in the scan volume;
controlledly generating a pulse sequence to excite NOR in the substance if present in the object;
amplifying said pulse sequence to produce sufficient magnetic field strength from the tuneable coil to irradiate the scan volume for detection purposes and cause an NOR transition to a detectable level within the substance if present within the object;
power matching to ensure optimum power transfer from the amplified pulse sequence to the tuneable coil at the requisite resonant frequency;
irradiating the entire scan volume reasonably uniformly with a pulsed magnetic field at the requisite resonant frequency created by the application of the amplified pulse sequence to the tuneable coil;
shielding the tuneable coil and scan volume to stop external interference from entering the scan volume and electromagnetic emissions from escaping from the coil and scan volume;
switching the pulsed magnetic field between high and low resonant frequencies as appropriate for exciting NOR in a substance within the object, maintaining a low equivalent series resistance with the tuneable coil during such switching;
amplifying a received signal from the coil after a delay from each transmitted pulse of the pulse sequence causing irradiation of the object and treating said received signal to improve the SNR;
isolating the tuneable coil from the amplification of the received signal;
processing the treated signal to separate out the phase and amplitude thereof;
comparing the measured phase and amplitude of the received signal with a known range or prescribed threshold; and
detecting whether the measured signal corresponds to an NQR signal emitted by the nuclei of the substance being tested, and if present issuing an alarm to notify an operator that the substance has been detected.

Preferably, said treating involves mixing the received signals with a reference and enhancing the mixed signals in quadrature.

Preferably, the method includes digitising and averaging the enhanced signals after each transmitted pulse until the pulse sequence has finished.

Preferably, the method includes accumulating or digital processing the digitised and averaged signals over the pulse sequence.

Preferably, the method includes separately matching and amplifying low and high frequency received signals.

Preferably, the method includes processing the accumulated signals by filtering, performing the fast Fourier transform, and cross-correlation techniques to separate out the phase and amplitude of the accumulated signals.

Preferably, the method includes electric field shielding the inside of the coil within the scan volume to limit and contain the electric field produced by the coil so that it interferes to the smallest possible extent with the object being scanned.

Preferably, the method includes measuring the temperature and calculating the requisite adjustment to the resonant frequency of the pulse sequence in the light thereof having regard to the substance being detected, and controlling the generating of the pulse sequences to the adjusted resonant frequency.

Preferably, the method includes reducing the Q factor of the coil to a minimum directly after a pulse of the pulse sequence is transmitted, and then returning the Q of the circuit to a high level for sensing and measuring the received signal.

Preferably, the method includes automatically transporting the object to be scanned to a position close to the centre of the coil within the scan volume, and to automatically stop the object at such position so that it can be scanned.

Preferably, the method includes further shielding to provide extra protection against external interference from entering the scan volume.

Preferably, the method includes controlling the generating of the pulse sequences to combat magnetoacoustic ringing and temperature induced intensity anomaly effects.

Preferably, the method includes preventing the escape of RF interference and preventing RF noise from entering the scan volume via the openings through which the object passes to and from the scan volume.

### BRIEF DESCRIPTION OF THE DRAWINGS

FIG. 1 shows a block diagram of the components of a practical NQR scanner in accordance with the first embodiment.

FIG. 2 shows a block diagram of the components of a practical NQR scanner in accordance with the third embodiment.

FIG. 3 shows a block diagram of the components of a practical NQR scanner in accordance with the fourth embodiment.

FIG. 4 shows a block diagram of the components of a practical NQR scanner in accordance with the fifth embodiment.

FIG. 5 shows a block diagram of the components of a practical NQR scanner in accordance with the sixth embodiment.

FIG. 6 shows a block diagram of the components of a practical NQR scanner in accordance with the tenth embodiment.

FIG. 7 shows a block diagram of the components of a practical NOR scanner in accordance with the eleventh embodiment.

FIG. 8 shows a practical NOR scanner.

FIG. 9 shows electromagnetic shielding doors attached to an NQR scanner.

### BEST MODE(S) FOR CARRYING OUT THE INVENTION

The best mode for carrying out the invention will now be described with reference to thirteen specific embodiments of an NOR scanner as illustrated in the Figures. In each of the following embodiments, the particular combination of the specific elements described has enabled the construction of a practical NOR scanner capable of detecting illicit substances. These embodiments of a NQR scanner have been arrived at after much experimentation.

The first embodiment of the best mode is directed towards an NOR scanner, and comprises specific elements described below.

Reference is made to FIG. 1 which is a block diagram of the entire NOR system.

A pulse generating means in the form of a Pulse Generator Controller (PGC) 1 generates an oscillating signal at the frequency of interest and converts it into a pulse sequence suitable for irradiating an object disposed within a coil 5 with RF energy and detecting NOR signals that may be excited within a substance contained within the object. Within the PGC 1 a direct digital synthesizer (DDS) generates a sinusoidal wave close to the NOR frequency of interest, which is typically between 0.5-6 MHz in frequency. This signal is gated by the rest of the PGC 1 to produce pulses of signal which are around a few hundred microseconds long and are spaced a similar amount apart. The DDS can also be configured to change phase, such that pulse sequences which require phase changes can be achieved.

Upon exit of the PGC 1 the signal is small and needs to be amplified to produce enough magnetic field within the coil 5 to cause an NQR transition. To achieve this task a high power amplifier 2 is used which amplifies the signal up to the kW level.

Next the signal passes through a power matching unit 3 which ensures optimum transfer of the power from the high power amplifier 2 to the coil at every frequency that the NQR scanner is intended to operate at. To ensure that any remaining signal does not enter the coil and receiver system after the power amplifier has finished transmitting, a diode isolator 4 is used to isolate the two sections. This diode isolator 4 will stop any signal below a certain level from entering the coil.

After traversing through the diode isolator 4 the signal is imparted into the coil 5, which is connected in parallel with a one or more fixing capacitors 6 to form a coil-capacitor circuit. The fixing capacitor(s) 6 fix the resonant frequency of the coil generally to that required for detecting a particular substance having quadrupole nuclei. The pulse signal imparted to the coil 5 generates an oscillating magnetic field of approximately 1-2 gauss. However, before this can be done, an object (not shown) is moved into the coil and stopped near the centre of the coil waiting to be scanned. After moving the object, such as a bag, into the coil, the resonant frequency of the system can be altered by the bag such that the coil-capacitor circuit is no longer resonant at the intended NQR frequency. This is because the bag may contain metallic items or other materials which alter the inductance and capacitance of the coil. To correct this problem the coil is re-tuned by adding in or subtracting out capacitance 9 to or from the resonant circuit. This addition or subtraction is achieved by switching relays.

An additional tuning switch is a low equivalent series resistance (ESR) switch 8 which enables the switching into the circuit of a large capacitance 7 required to shift the resonant frequency to and from a high or low frequency. The use of this low ESR switch 8 avoids injecting a large equivalent series resistance and thus maintains high Q in the circuit at low frequencies.

After the tuning has been completed, the high power signal is sent from the diode isolator 4 to the coil 5. As stated in the preceding description, spiral, multi-turn solenoids, and most other coils are not suitable for use in a practical NQR scanner. This leaves few choices for practical NQR scanning. One choice is to use a multiple loop coil, which consists of multiple loops connected in parallel (FIG. 12). This design has the following desirable properties:
(a) Reasonably uniform magnetic field.
(b) High Q.
(c) The electric field can be confined to a small volume mostly isolated away from the sample.

Most other coil designs are deficient in one or more properties and are not suitable for use as a large volume scanner.

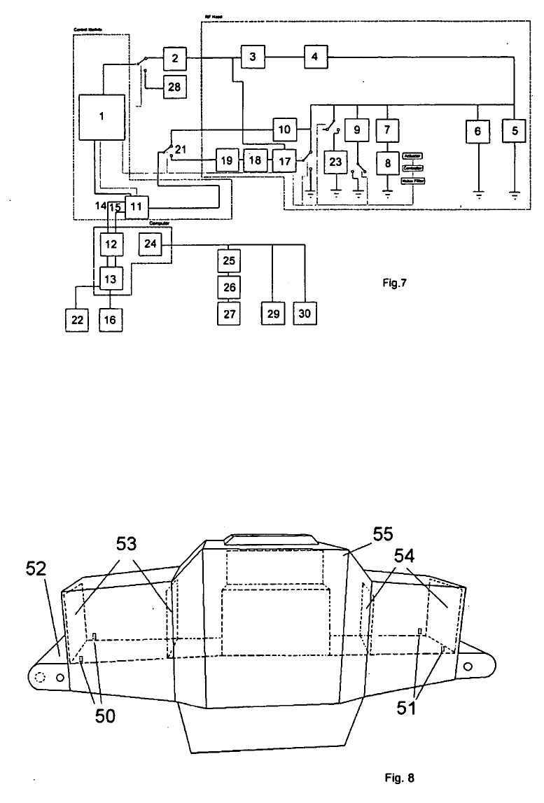

The electromagnetic shield design (55 in FIG. 8) is required to be made from sheet metal and be spaced far enough from the coil such that it doesn't substantially degrade the Q of the coil. The closer the shield is to the coil, the greater the increase in resistance and loss of inductance, resulting in lower Q. By moving the shield far enough away from the coil, the Q limits towards a maximum value. There are obviously practical limits to how far the shield can be moved away from the coil, hence a reasonable spacing between the coil and shield is half the coil dimension in that direction. The coil and waveguide separation is approximately half of the length of the coil. Any closer than this also substantially degrades the Q of the system. The waveguide can be made of any length provided cancellation of the external noise occurs. The best length for the waveguides has been found to be the same as the coil length for NQR frequencies.

The measurement process begins by operating the receiver system after a prescribed delay time from transmitting the pulse sequence to the coil to irradiate the scan volume with an oscillating magnetic field as previously described. Essentially, the measurement process involves sending the received signal from the coil to the receiver system, which includes an amplification unit, comprising a small signal amplifier 10, and a mixer 11. After amplification the signal is mixed with a reference signal from the PGC 1 at the mixer 11 forming a quadrature signal 14,15. Because of the mixing process, the mixed signals lie in the kHz region whereas the original signal consisted of signals in the MHz region. The two channels are sent to an ADC 12 for conversion into digital signals by sampling at regular intervals. Here the signal is averaged after each pulse until the pulse sequence is finished. After the averaging process is completed the result is sent to a computer 13 to be filtered and fast Fourier transformed to separate out the phase and amplitude of the signal. The process ends with the measured amplitude and/or phase being compared to a known range or against a threshold.

If one or more of the measured signal's parameters do lie within a measured range or above a threshold, then the operator is alerted by an audible alarm or visible display unit 16.

The second embodiment is substantially the same as the first, except that the coil 5 used is a single turn sheet coil (FIG. 10). The single turn sheet coil has a high Q, substantially uniform magnetic field and the electric field is confined to a small area away from the coil similar to the multi loop coil.

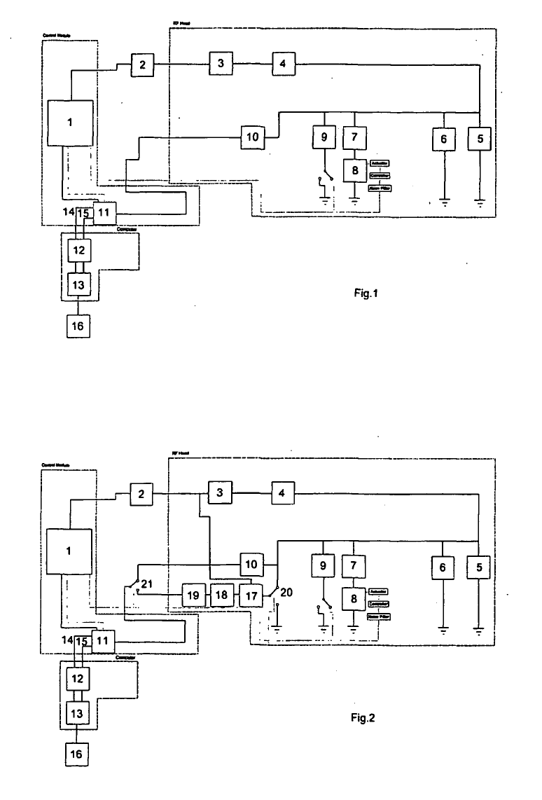

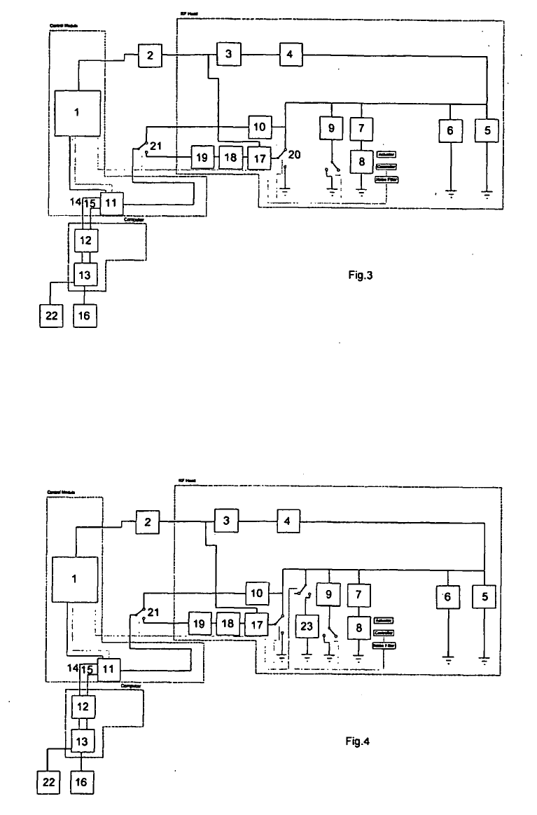

The third embodiment (FIG. 2) is substantially the same as the first or second embodiments, except that the amplification of the small return signal emanating from the coil is achieved by using two different amplifiers. The first amplifier is used for amplification of low frequency NQR signals and comprises a cold damped amplifier consisting of an isolator 17, a matching section 18 and an amplifier 19. The second amplifier is used for amplification of high frequency NQR signals and consists of a high impedance amplifier 10. The matching section ensures maximum transfer efficiency of the signal. The use of two different amplifiers for each different frequency range has been shown to have superior qualities over other amplification techniques. The switches 20 and 21 select which path the signal will follow.

The fourth embodiment (FIG. 3) is substantially the same as the first to third embodiments except that a temperature probe or probes 22 are added to provide a faster scan time and more accurate results than previous methods. Unlike the first embodiment, in this embodiment a pulse sequence is generated to transmit to the coil in accordance with the following method. First, the ambient temperature is sensed by one or more probes 22. The temperature or temperatures are converted into a frequency for each substance to be scanned by looking up a conversion table in the computers 13 memory or calculating the frequency corresponding to the temperature. The signal close to the calculated frequency from an RF source is sent to the PGC 1. The PGC 1 has stored within its memory a pulse sequence for each substance and hence the oscillating wave within the pulses of the pulse sequence are transmitted out of the PGC 1 at the calculated frequency.

In variations of the present embodiment, instead of, or in addition to, the temperature probe measuring the ambient temperature, the temperature probe measures the external area temperature, the external temperature of the object to be scanned, or the internal temperature of the object to be scanned. This is achieved by using additional or alternative temperatures for each temperature measured.

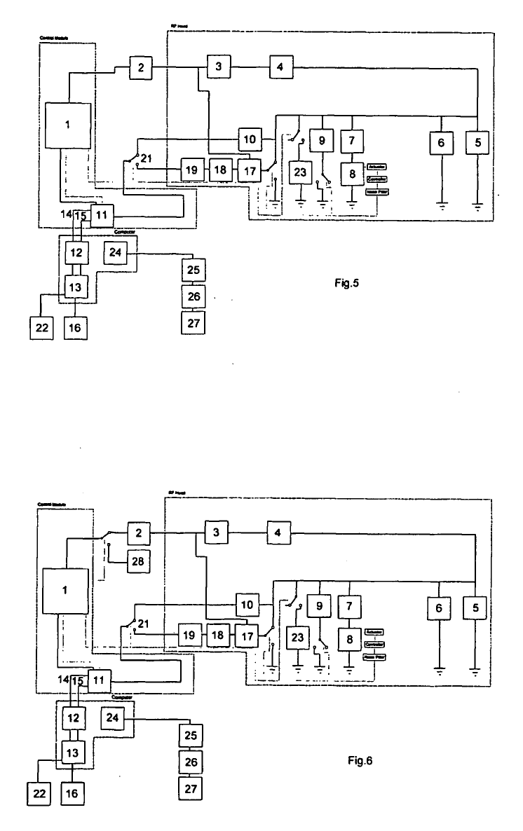

The fifth embodiment (FIG. 4) is substantially the same as the first to the fourth except that a Q switch 23 is added to the system. Ordinarily after the transmit pulse has been applied to the coil 5, the coil 5 can ring for several milliseconds which limits its usefulness as a detection coil and degrades its sensitivity. To overcome this problem a Q switch 23 is provided to reduce the Q factor of the coil circuit to a minimum directly after a pulse is transmitted, and then return the Q of the circuit to a high level for sensing and measuring the received signal. This enables the coil ringdown to be reduced allowing the measurement acquisition cycle to begin much sooner and thus gain sensitivity compared with previous methods.

The addition of two triacs in parallel with the coil has found to be best method of causing the ringdown to be the shortest, enabling measurements to begin sooner than what would have been otherwise possible under different Q switches.

The sixth embodiment (FIG. 5) is substantially the same as the first to the fifth except that a high speed conveyor belt system (52 in FIG. 8) is added to the NQR scanner to save time in transporting the bags etc into the scan system. Typical belt speeds for X-ray devices are around 20 cm/s. However this is not fast enough for time critical NQR measurements. A belt speed near 0.5 m/s enables the bag to move quickly into the scan area without so fast as to be dangerous or cause damage to the item being transported.

The conveyor belt system includes a conveyor belt controller 25 to automatically transport an object to be scanned along a conveyor belt 26 to a position close to the centre of the coil 5, and to automatically stop the object at such position so that it can be subsequently scanned. An emergency stop 27 is provided to allow the controller 25 to be overridden in the event of an emergency.

The seventh embodiment is substantially the same as the first to the sixth embodiments except that an extra outer shield (not shown) is added to provide extra protection against external interference from entering the scan volume. Radio stations have particularly powerful transmissions in urbanised areas and have been found to cause leakage into the receiver system. An extra outer shield spaced as little as 2 mm from the inner shield is sufficient to fix this problem.

The eighth embodiment is substantially the same as the first to the seventh except that the pulse sequences used combat both magnetoacoustic ringing from the sample being scanned and temperature effects caused by the temperature anomaly effect in NQR. Nearly all items scanned exhibit some degree of magnetoacoustic ringing due to metal content on the items being scanned. Therefore a practical scanner needs to use only magnetoacoustic pulse sequences to overcome this problem. The temperature anomaly effect occurs when the signal intensity received at various offsets from the resonance frequency reduces in a cyclical fashion. Some pulse sequences however can overcome this effect by producing a constant intensity regardless of the offset from the resonance frequency. For a practical NQR scanner it therefore is necessary to use a pulse sequence which overcomes magnetoacoustic ringing and the temperature induced intensity anomaly effect.

The ninth embodiment is substantially the same as the first to the eighth except that rubber backed copper curtains (53, 54 in FIG. 8) capable of screening the interior volume from external radio interference and to help prevent the escape of high frequency radiation from the NQR system. Ordinarily a Waveguide is capable of blocking frequencies below a certain frequency, however above a certain frequency the waveguide is completely transparent to some frequencies which means these frequencies can be sensed by the receiver system and conversely can be radiated out by the NQR scanner into the surrounding environment. Frequencies that manage to penetrate into the receiver system can be mixed down with other high frequencies resulting in noise at the frequency of interest. Frequencies which escape the NQR scanner, because of their high electromagnetic frequency can cause possible occupational, health and safety concerns. To prevent either situation occurring curtains are attached either end of the waveguides. The copper within the curtains absorb any radiated emissions in either direction preventing the occurrence of interference and emanating emissions from the device. To ensure the curtains perform correctly when bags are ‘stuck’ directly underneath the curtains multiple curtains can be used by placing one or more curtain sets spread out through the waveguide (FIG. 8).

In a variation of the present embodiment, openable and closeable doors suitably lined with metal are provided in lieu of curtains to prevent the emission or ingression of RF electromagnetic interference and noise.

The tenth embodiment (FIG. 6) is substantially the same as the first to the ninth except that tuning probe 28 is added to the NQR scanner. This tuning probe is a small circular piece of copper wire of a diameter of approximately 30 mm and is placed directly underneath one edge of the coil half way between the coil and the shield. To tune the coil a small signal is sent into this coil and the tuning capacitors 9 of the coil are stepped through their maximum range of values. The voltage on the coil at each tuning capacitor value is sent to the ADC/DSP 12 where it is digitised and processed to produce an intensity versus capacitor value array, of which the peak value indicates the best tuning capacitor value to use. This capacitor value is then used for scanning the particular substance being scanned on the bag that lies within the coil.

The eleventh embodiment (FIG. 7) is substantially the same as the first to the tenth except that an optical fence 29 is used to sense the presence of an object such as a bag. An NQR system requires that the bag be stopped in the centre of the scan to perform the scan. As the scan can take substantial time (on the order of 10 seconds) then it is not practical to have the bag moving at any speed while scanning takes place. It is also not practical to have the bag moving because pulse sequences used to combat magnetoacoustic ringing will not function as well as when the bag is stationary. When the machine begins operation the conveyor belt is set in motion. The optical fence 29 (50 in FIG. 8) senses a bag when it breaks its line of sight. This signal informs the computer that a bag is present and is waiting to be scanned. The bag is transported to the near the centre of the coil where it is scanned. After the bag has been scanned it transported to the end of the coil where the bag breaks another line of sight of a second optical fence. The signal sent after this occurs informs the computer that the bag has exited the system.

The twelfth embodiment (FIG. 7) is substantially the same as the first to the eleventh embodiment except that a remote operating pod (ROP) 30 is added. The ROP 30 is used to inform the operator of the machine the status of the system without the need for looking at a monitor, as generally the machine is configured with rack mounted computer, but no monitor. The ROP 30 has a display indicating which explosives it scanned for and the results of that scan. It can indicate red, green, or amber which indicates detection successful, bag is clear or an indeterminate result. It also informs the operator when it is in the process scanning, gives an indication when the bags are too closely spaced, informs the operator whether it is in manual or auto mode and can give control of the conveyor belt to the operator overriding the computer, which is useful in busy periods of machine operation.

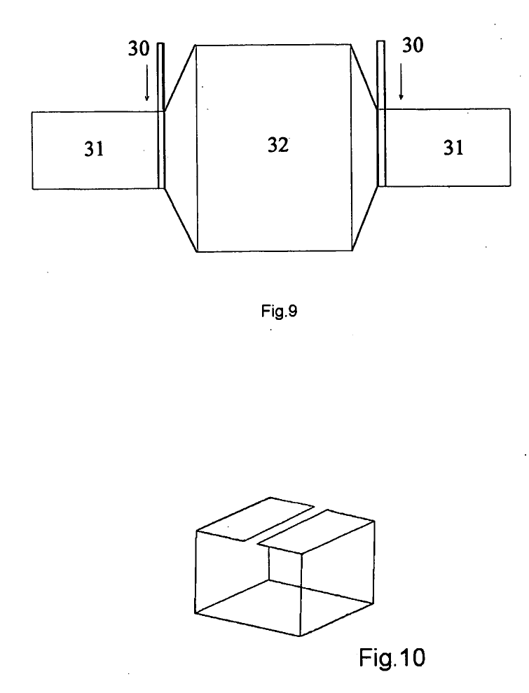

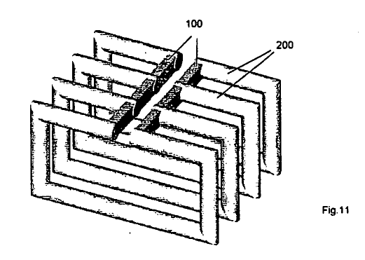

The thirteenth embodiment which is substantially the same as the first to the twelfth embodiments except that the waveguides are either replaced by doors or doors are inserted into the system, preferably between the main part of the shield and the waveguides. Under this embodiment the curtains may be removed as they will be partially redundant. FIG. 9 shows a side view of the NQR scanner with doors 30 attached between the main part of the shield 32 and the waveguides 31.

When using the doors without waveguides, the overall machine can be shortened allowing the machine to fit in tight spaces, whereas other devices such as X-ray machines cannot. When the doors 30 are open (as shown in FIG. 9), a bag is moved into position and then the doors 30 are shut. This prevents the escape of RF signals from the machine and stops RF noise from getting into the scan volume. Once the scan process is finished the doors 30 are opened and the bag is free to move forward, exiting the machine.

It should be appreciated that the scope of the present invention is not limited to the particular embodiments described herein, and that minor changes or variations to the elements may be made that do not depart from the spirit of the invention and thus remain within its scope.

1. An NQR scanner for detecting the presence of a substance containing quadrupole nuclei within an object comprising:
a pulse generating means to generate pulse sequences that are used to irradiate the object in a pulsed magnetic field at a requisite NQR frequency for the substance to be detected;
a high power RF transmit amplifier for amplifying said pulse sequences to produce sufficient magnetic field strength to irradiate a scan volume within which the object is disposed for detection purposes and cause an NQR transition to a detectable level within the substance if present within the object;
a high Q, tunable coil for producing a reasonably uniform magnetic field over the entire scan volume, connected into a tunable circuit for varying the resonant frequency thereof;
a power matching unit to ensure optimum power transfer from said transmit amplifier to said coil at substantially every frequency the NQR scanner operates;
an electromagnetic shield to fully enclose the coil allowing an opening to pass the object into the scan volume for detection, said electromagnetic shield being adapted to stop external interference from entering the scan volume and electromagnetic emissions from escaping from the coil and scan volume;
a tuning subsystem to determine if the introduction of the object into the scan volume has altered the resonant frequency of the scanning for the substance, and to re-tune the scanner to the requisite resonant frequency;
a low equivalent series resistance (ESR) switch to switch a large capacitance into and out of the tuneable circuit for changing between low and high resonant frequencies, whilst maintaining a low equivalent series resistance to maintain a high Q in the circuit at low resonant frequencies;
a receiver system for amplifying a received signal from the coil after a delay from each transmitted pulse of the pulse sequence causing irradiation of the object and treating said received signal to improve the SNR;
processing means to process the treated signal to separate out the phase and amplitude thereof and control the pulse generating means;
an isolator to isolate the coil from the receiver system;
comparator means for comparing the measured phase and amplitude of the received signal with a known range or prescribed threshold; and
detection means to detect whether the measured signal corresponds to an NQR signal emitted by the nuclei of the substance being tested, and if present issue an alarm to notify an operator of the scanner that the substance has been detected.

2. An NQR scanner as claimed in claim 1, wherein the receiving system comprises:
(i) amplification means to amplify the received signals;
(ii) a mixer to mix and enhance the received signals for improving the SNR;
(iii) an analogue-to-digital converter to digitise the enhanced signals and average the signal after each transmitted pulse until the pulse sequence has finished for subsequent digital processing; and
(iv) an accumulator or digital signal processor to accumulate the digitised and averaged signals over the pulse sequence.

3. An NQR scanner as claimed in claim 2, wherein said amplification means comprises a small signal amplifier.

4. An NQR scanner as claimed in claim 2, wherein said amplification means comprises a cold damped amplifier consisting of a matching system and amplifier for amplifying low frequency received signals, and a high impedance amplifier for amplifying high frequency received signals.

5. An NQR scanner as claimed in claim 2, wherein said processing means comprises a computer to process the accumulated signals by filtering, performing the fast Fourier transform, and cross-correlation techniques to separate out the phase and amplitude of the accumulated signals.

6. An NQR scanner as claimed in claim 1, wherein the coil is a multiple loop coil.

7. An NQR scanner as claimed in claim 1, wherein the coil is a sheet single turn coil.

8. An NQR scanner as claimed in claim 1, wherein the scanner includes an electric field shield circumscribing the inside of the coil within the scan volume to limit and contain the electric field produced by the coil so that it interferes to the smallest possible extent with the object being scanned.

9. An NQR scanner as claimed in claim 1, including a temperature probe to measure the temperature, and said processing means calculating the requisite adjustment to the resonant frequency of the pulse sequence in the light of the temperature having regard to the substance being detected and controlling the pulse generating means to generate the pulse sequence at the adjusted resonant frequency.

10. An NQR scanner as claimed in claim 1, including a Q switch to reduce the Q factor of the coil circuit to a minimum directly after a pulse of the pulse sequence is transmitted, and then return the Q of the circuit to a high level for sensing and measuring the received signal.

11. An NQR scanner as claimed in claim 1, including a conveyor belt controllable to automatically transport an object to be scanned to a position close to the center of the coil, and to automatically stop the object at such position so that it can be scanned.

12. An NQR scanner as claimed in claim 1, including a second outer shield to provide extra protection against external interference from entering the scan volume.

13. An NQR scanner as claimed in claim 1, wherein said pulse generating means is controlled to generate pulse sequences that combat magnetoacoustic ringing and temperature induced intensity anomaly effects.

14. An NQR scanner as claimed in claim 1, including RF curtains to prevent the escape of RF interference and prevent RF noise from entering the scan volume.

15. An NQR scanner as claimed in claim 14, wherein said RF curtains comprise a rubber backed copper curtain.

16. An NQR scanner as claimed in claim 1, including doors to prevent the escape of RF interference and prevent RF noise entering the scan volume.

17. An NQR scanner as claimed in claim 1, including a tuning probe disposed part way between the coil and the shield for the purposes of tuning the coil to the requisite frequency for detection purposes prior to scanning an object brought into the scan volume of the coil.

18. An NQR scanner as claimed in claim 1, including an optical fence system to sense the presence of an object approaching the scanner for scanning, to control the conveyance of the object to the scan volume for scanning and to control subsequent discharge of the object therefrom after scanning.

19. An NQR scanner as claimed in claim 1, including a remote operating pod for informing an operator of the scanner the status of the system without the need for looking at a monitor.

20. A method for detecting the presence of a substance containing quadrupole nuclei within an object, comprising:
conveying an object to a scan volume;
determining whether the introduction of the object into the scan volume has altered the resonant frequency for detecting a prescribed substance having quadrupole nuclei within the object;
re-tuning a high Q, tunable coil to the requisite resonant frequency with the object in the scan volume;
controlledly generating a pulse sequence to excite NQR in the substance if present in the object;
amplifying said pulse sequence to produce sufficient magnetic field strength from the tuneable coil to irradiate the scan volume for detection purposes and cause an NQR transition to a detectable level within the substance if present within the object;
power matching to ensure optimum power transfer from the amplified pulse sequence to the tuneable coil at the requisite resonant frequency;
irradiating the entire scan volume reasonably uniformly with a pulsed magnetic field at the requisite resonant frequency created by the application of the amplified pulse sequence to the tunable coil;
shielding the tunable coil and scan volume to stop external interference from entering the scan volume and electromagnetic emissions from escaping from the coil and scan volume;
switching the pulsed magnetic field between high and low resonant frequencies as appropriate for exciting NQR in a substance within the object, maintaining a low equivalent series resistance with the tunable coil during such switching;
amplifying a received signal from the coil after a delay from each transmitted pulse of the pulse sequence causing irradiation of the object and treating said received signal to improve the SNR;
isolating the tunable coil from the amplification of the received signal;
processing the treated signal to separate out the phase and amplitude thereof;
comparing the measured phase and amplitude of the received signal with a known range or prescribed threshold; and
detecting whether the measured signal corresponds to an NQR signal emitted by the nuclei of the substance being tested, and if present issuing an alarm to notify an operator that the substance has been detected.

21. A method as claimed in claim 20, wherein said treating involves mixing the received signals with a reference and enhancing the mixed signals in quadrature.

22. A method as claimed in claim 21, including digitising and averaging the enhanced signals after each transmitted pulse until the pulse sequence has finished.

23. A method as claimed in claim 22, including accumulating or digital processing the digitised and averaged signals over the pulse sequence.

24. A method as claimed in claim 1, including separately matching and amplifying low and high frequency received signals.

25. A method as claimed in claim 23, including processing the accumulated signals by filtering, performing the fast Fourier transform, and cross-correlation techniques to separate out the phase and amplitude of the accumulated signals.

26. A method as claimed in claim 20, including electric field shielding the inside of the coil within the scan volume to limit and contain the electric field produced by the coil so that it interferes to the smallest possible extent with the object being scanned.

27. A method as claimed in claim 20, including measuring the temperature and calculating the requisite adjustment to the resonant frequency of the pulse sequence in the light thereof having regard to the substance being detected, and controlling the generating of the pulse sequences to the adjusted resonant frequency.

28. A method as claimed in claim 20, including reducing the Q factor of the coil to a minimum directly after a pulse of the pulse sequence is transmitted, and then returning the Q of the circuit to a high level for sensing and measuring the received signal.

29. A method as claimed in claim 20, including automatically transporting the object to be scanned to a position close to the center of the coil within the scan volume, and to automatically stop the object at such position so that it can be scanned.

30. A method as claimed in claim 20, including further shielding to provide extra protection against external interference from entering the scan volume.

31. A method as claimed in claim 20, including controlling the generating of the pulse sequences to combat magnetoacoustic ringing and temperature induced intensity anomaly effects.

32. A method as claimed in claim 20, including preventing the escape of RF interference and preventing RF noise from entering the scan volume via the openings through which the object passes to and from the scan volume.

33. (canceled)

34. (canceled)
